(19) United States
(12) Patent Application Publication
(10) Pub. No.: US 2026/0093526 A1
(43) Pub. Date: Apr. 2, 2026

(54) LOAD BALANCING METHOD FOR DISTRIBUTED SYSTEM, ELECTRONIC DEVICE, NON-TRANSITORY COMPUTER-READABLE STORAGE MEDIUM

(71) Applicant: Beijing Volcano Engine Technology Co., Ltd., Beijing (CN)

(72) Inventors: Yanbin CHEN, Beijing (CN); Tao LI, Beijing (CN)

(21) Appl. No.: 19/245,165

(22) Filed: Jun. 20, 2025

(30) Foreign Application Priority Data
Sep. 30, 2024 (CN) 202411389290.3

(51) Int. Cl. G06F 9/48

(52) U.S. Cl. CPC G06F 9/4881

(57) ABSTRACT

The present disclosure relates to a load balancing method for a distributed system, an electronic device, and a non-transitory computer-readable storage medium. The method includes: determining a multi-dimensional load vector of each of service nodes based on dimensional resource usage indicators of each of service replicas carried on the each of the service nodes in the distributed system in multiple dimensions; classifying the service nodes into multiple load intervals based on the multi-dimensional load vector and a target load vector of each of the service nodes; determining multiple candidate scheduling strategies and corresponding load balancing gains based on the multiple load intervals; and selecting, from the multiple candidate scheduling strategies, a candidate scheduling strategy with a largest load balancing gain as a target scheduling strategy, and executing the target scheduling strategy.

### CROSS-REFERENCE TO RELATED APPLICATION

This application claims the priority to and benefits of the Chinese Patent Application No. 202411389290.3, which was filed on September 30, 2024. The aforementioned patent application is hereby incorporated by reference in its entirety.

### TECHNICAL FIELD

The present disclosure relates to a load balancing method for a distributed system, an electronic device, and a non-transitory computer-readable storage medium.

### BACKGROUND

Load balancing is an important mechanism in a distributed system, and an excellent load balancing method may significantly improve resource utilization of the system and reduce costs.

At present, load balancing methods mainly include: a load balancing method based on the number of replicas, which evenly distributes respective replicas of users across respective physical machines; a load balancing method based on queries per second (Queries Per Second, QPS), which schedules replicas from a physical machine with high QPS to a physical machine with low QPS, to achieve QPS balance between the physical machines; and a load balancing method based on disk space capacity, which schedules replicas from a physical machine with high disk space utilization to a physical machine with low disk space utilization, to achieve disk space utilization balance across the physical machines.

However, none of the above load balancing methods can well balance utilization of various resources in the distributed system, resulting in limited overall resource utilization of the distributed system and high system costs.

### SUMMARY

In order to solve the above technical problems, embodiments of the present disclosure provide a load balancing method for a distributed system, an electronic device, and a non-transitory computer-readable storage medium.

An embodiment of the present disclosure provides a load balancing method for a distributed system, the method including: determining a multi-dimensional load vector of each of service nodes based on resource usage indicators of each of service replicas carried on each of the service nodes in the distributed system in multiple dimensions, where the multi-dimensional load vector represents a resource utilization of each of the service nodes in multiple dimensions; classifying the service nodes into multiple load intervals based on the multi-dimensional load vector and a target load vector of each of the service nodes, where the multiple load intervals at least includes a high load interval and a low load interval; determining multiple candidate scheduling strategies and corresponding load balancing gains based on the multiple load intervals, where each of the multiple candidate scheduling strategies instructs to schedule a specified service replica carried by a specified service node in the high load interval to a specified service node in the low load interval; and selecting, from the multiple candidate scheduling strategies, a candidate scheduling strategy with a largest load balancing gain as a target scheduling strategy, and executing the target scheduling strategy, where the largest load balancing gain represents that a distance between the multi-dimensional load vector and the target load vector of each of the service nodes are reduced after participating in scheduling of the service replicas, with a largest reduction value of the distance.

Embodiments of the present disclosure further provides a load balancing apparatus for a distributed system, the apparatus including: a multi-dimensional load vector determination module, configured to determine a multi-dimensional load vector of each of service nodes based on resource usage indicators of each of service replicas carried on each of the service nodes in the distributed system in multiple dimensions, where the multi-dimensional load vector represents a resource utilization of each of the service nodes in multiple dimensions; a load interval division module, configured to classify the service nodes into multiple load intervals based on the multi-dimensional load vector and a target load vector of each of the service nodes, where the multiple load intervals at least include a high load interval and a low load interval; a candidate scheduling strategy determination module, configured to determine multiple candidate scheduling strategies and corresponding load balancing gains based on the multiple load intervals, where each of the multiple candidate scheduling strategies instructs to schedule a specified service replica carried by a specified service node in the high load interval to a specified service node in the low load interval; and a target scheduling strategy executing module, configured to selecting, from the multiple candidate scheduling strategies, a candidate scheduling strategy with a largest load balancing gain as a target scheduling strategy, and executing the target scheduling strategy, where the largest load balancing gain represents that a distance between the multi-dimensional load vector and the target load vector of each of the service nodes are reduced after participating in scheduling of the service replicas, with a largest reduction value of the distance.

Embodiments of the present disclosure further provides an electronic device, the electronic device including: at least one processor; and a memory, configured to store an executable instruction; where the at least one processor is configured to read the executable instruction from the memory and execute the executable instruction to implement the load balancing method for the distributed system according to any of embodiments of the present disclosure.

Embodiments of the present disclosure further provides a non-transitory computer-readable storage medium, the storage medium storing a computer program, where the computer program, when executed by a processor, causes the processor to implement the load balancing method for the distributed system according to any of embodiments of the present disclosure.

Embodiments of the present disclosure further provides a computer program product, the computer program product being configured to perform the load balancing method for the distributed system according to any of embodiments of the present disclosure

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a schematic flowchart of a load balancing method for a distributed system according to an embodiment of the present disclosure;

FIG. 2 is a schematic diagram of distribution of resource usage indicators of two service nodes in a throughput dimension over time according to an embodiment of the present disclosure;

FIG. 3 is a schematic diagram of the principle of multiple load intervals and scheduling of a service replica according to an embodiment of the present disclosure;

FIG. 4 is a schematic diagram of distribution of service nodes with different multi-dimensional load vectors according to an embodiment of the present disclosure;

FIG. 5 is a schematic flowchart of S130 in the load balancing method for a distributed system shown in FIG. 1 according to an embodiment of the present disclosure;

FIG. 6 is a schematic diagram of the principle of determining a candidate scheduling strategy in the load balancing method for a distributed system according to an embodiment of the present disclosure;

FIG. 7 is a comparison diagram of distribution of service replicas in a system before and after the load balancing method for a distributed system is performed according to an embodiment of the present disclosure;

FIG. 8 is a schematic structural diagram of a load balancing apparatus for a distributed system according to an embodiment of the present disclosure; and

FIG. 9 is a schematic structural diagram of an electronic device according to an embodiment of the present disclosure

### DETAILED DESCRIPTION

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and the embodiments of the present disclosure are only for exemplary purposes, and are not intended to limit the scope of protection of the present disclosure.

It should be understood that the various steps described in the method embodiments of the present disclosure may be performed in different orders, and/or performed in parallel. Furthermore, additional steps may be included and/or the execution of the illustrated steps may be omitted in the method embodiments. The scope of the present disclosure is not limited in this respect.

The term "include/comprise" used herein and the variations thereof are an open-ended inclusion, namely, "include/comprise but not limited to". The term "based on" means "at least partially based on". The term "an embodiment" means "at least one embodiment". The term "another embodiment" means "at least one another embodiment". The term "some embodiments" means "at least some embodiments". Related definitions of the other terms will be given in the description below.

It should be noted that concepts such as "first," "second," etc. mentioned in the present disclosure are only used to distinguish different apparatuses, modules, or units, and are not intended to limit orders or interdependence relationships of functions performed by these apparatuses, modules, or units.

It should be noted that modifications of "one" and "more" mentioned in the present disclosure are schematic rather than restrictive, and those skilled in the art should understand that otherwise explicitly stated in the context, it should be understood as "one or more".

The names of messages or information exchanged between a plurality of apparatuses in the embodiments of the present disclosure are used for illustrative purposes only, and are not indicated to limit the scope of these messages or information.

The load balancing method for a distributed system in the related art mainly performs scheduling of a service replica in the system in a single load dimension such as the number of service replicas, queries per second (Queries Per Second, QPS) or CPU utilization, disk space capacity, or disk space utilization and so on. However, it is difficult for the load balancing method in a single dimension to utilize resources of a service node in multiple dimensions at the same time, and the load balancing method in the single dimension may only achieve balance of resources of the service node in a single load dimension. For example, after QPS balance, disk space utilization may be tilted; and after disk space utilization balance, resource utilization in dimensions such as QPS or CPU utilization of the service node may be tilted.

In order to solve the technical problem that overall resource utilization of the system is still low due to the above single-dimensional load balancing, a multi-dimensional load balancing strategy may be adopted. However, the multi-dimensional load balancing has at least the following problems that need to be solved urgently: (1) how to correctly evaluate whether a service node is a high-load service node or a low-load service node? (2) how to balance multi-dimensional resources at the same time? (3) loads of the same service in different time periods may be different, so how to quantify a dynamic load? (4) how to better support expansion of load dimensions? Based on this, embodiments of the present disclosure provide a load balancing solution for a distributed system to solve various problems existing in the above multi-dimensional load balancing method step by step. For specific solutions, reference may be made to the following detailed description of respective embodiments.

The load balancing method for a distributed system according to the embodiments of the present disclosure may be executed by a load balancing apparatus for a distributed system. The apparatus may be implemented in software and/or hardware, and may be integrated in an electronic device with overall control functions in the distributed system, for example, an electronic device in which a metadata server (Metadata service) in the distributed system is located. The electronic device may include but is not limited to a laptop, a desktop computer, a server, and the like.

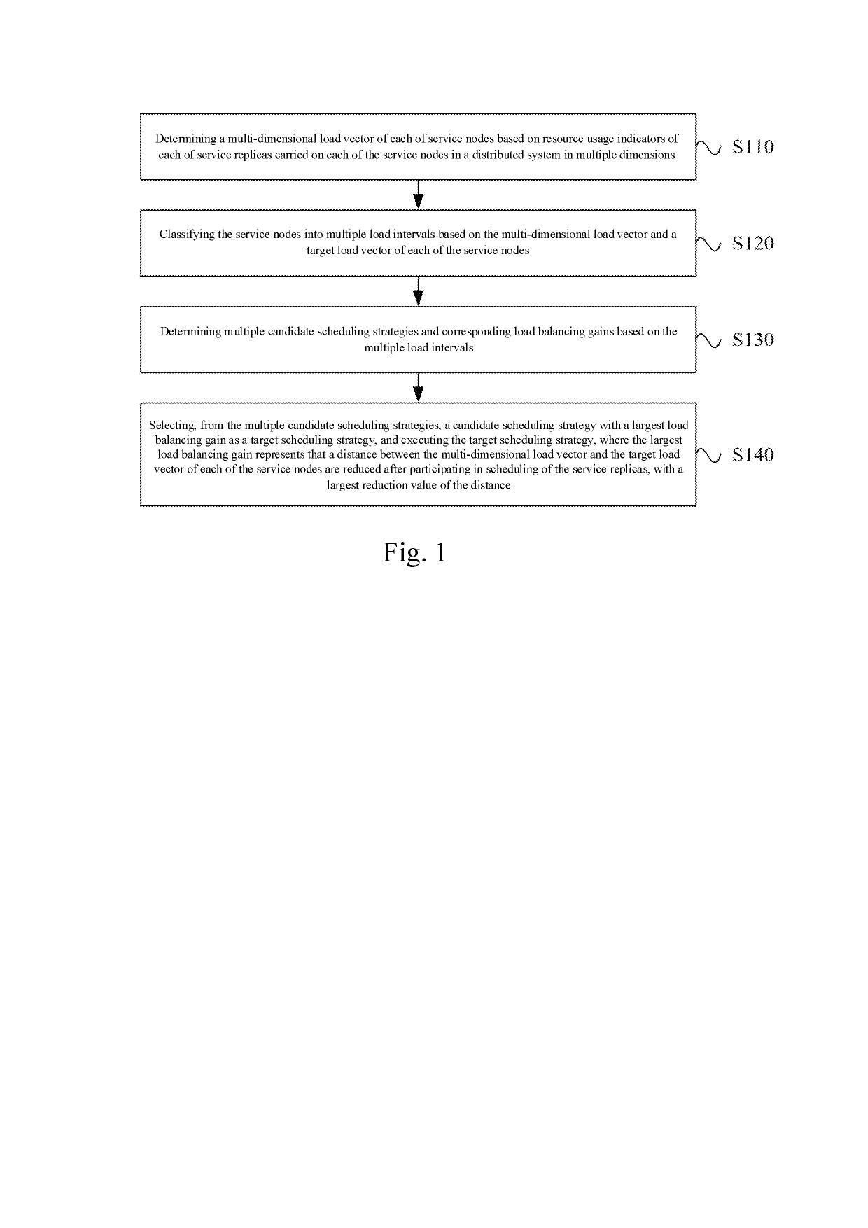

FIG. 1 shows a schematic flowchart of a load balancing method for a distributed system according to an embodiment of the present disclosure. As shown in FIG. 1, the load balancing method for a distributed system may include the following steps S110, S120, S130 and S140.

At step S110, a multi-dimensional load vector of each of service nodes is determined based on resource usage indicators of each of service replicas carried on each of the service nodes in the distributed system in multiple dimensions.

The multi-dimensional load vector represents a resource utilization of each of the service nodes in multiple dimensions. Exemplarily, the multi-dimensional load vector includes load values in multiple dimensions that measure the processing performance of the distributed system. The load value is a result of quantifying the resource usage. The multiple dimensions at least include at least two of a throughput dimension, a disk space utilization dimension, a disk input/output dimension, a disk access frequency dimension, a CPU utilization dimension, a QPS dimension, a memory utilization dimension, a network bandwidth utilization dimension, and an average response time dimension. The dimension herein may also be referred to as a load dimension. It should be noted that the multiple dimensions in the embodiments of the present disclosure may be conveniently extended, and reference may be made to the related description of subsequent embodiments for details. The resource utilization herein may be a dynamic load value at the current moment, or a statistical load value in consideration of a historical load, an abnormal load, and the like.

Specifically, the electronic device may collect a load value of each of the service nodes alive in the system in each load dimension. In an aspect, if the multi-dimensional load vector is a dynamic load value at a current moment, the multi-dimensional load vector may be determined directly based on the collected load values in the multiple dimensions; and if the multi-dimensional load vector is a statistical load value, statistical calculation may be performed on the load values based on a load aggregation manner (for example, performing summation, maximum calculation, and average calculation in each dimension) to obtain the multi-dimensional load vector. In another aspect, if the service node may report the load value in each load dimension, the multi-dimensional load vector may be determined directly based on the reported load value; and if the service node reports the load value of each of the service replicas stored therein in each load dimension, the multi-dimensional load values of the service replicas may be summarized according to the load dimensions through the load aggregation manner to obtain the multi-dimensional load vector of the corresponding service node.

In some embodiments, S110 includes the following steps A to C.

At step A, in multiple statistical unit time, average values of the resource usage indicators generated by each of service replicas carried by each of service nodes in each of the multiple statistical unit time are acquired in the multiple dimensions.

The statistical unit time is a statistical duration with a preset minimum granularity, and for example, may be half an hour, one hour, two hours, or the like.

Specifically, the electronic device may, for each of the service replicas in each service node, perform average value statistics on the resource usage indicators collected by the service replica in each load dimension according to the statistical unit time to obtain a plurality of statistical average values of the service replica in each load dimension. For example, if the statistical unit time is one hour, the electronic device may obtain the average value of the resource usage indicators of each of the service replicas in each of the service nodes in each load dimension per hour. In this way, the interference of occasional jitter load in the service replicas may be shielded by setting the statistical unit time and performing the average value statistical processing, thereby improving the accuracy of load balancing to a certain extent.

At step B, a multi-dimensional load vector of each of the service replicas is generated based on a maximum value of the average values of the resource usage indicators generated during the multiple statistical unit time.

Specifically, for each of the service replicas in each of the service nodes in each load dimension, the electronic device may determine the average value of the resource usage indicators in each of the statistical unit time in each preset period, and an initial load vector corresponding to the preset period is formed with each average value. Then, comparison processing is performed on the third preset number of initial load vectors in element-by-element positions to determine a maximum value in each of the element positions, and a load vector of the service replica in the load dimension is formed with the maximum values. Then, the multi-dimensional load vector of each of the service replicas may be obtained by performing the above processing in the multiple load dimensions.

The preset period in the above process is a statistical duration with a preset larger granularity, and for example, may be half a day or one day. The third preset number is a preset number, which may be set according to business requirements. Exemplarily, the third preset number is greater than or equal to seven. In this way, the calculated multi-dimensional load vector of the service replica may cover at least resource usage indicators in one week, so as to statistically analyze the changing patterns of business traffic as much as possible, thereby further improving the accuracy of the multi-dimensional load vector and further improving the accuracy of load balancing.

Taking the load dimension being the QPS dimension, the third preset number being seven, the preset period being one day, and the statistical unit time being one hour as an example, the electronic device may collect all resource usage indicators of a certain service replica reported by a certain service node within seven days in the QPS dimension. Then, the electronic device may extract resource usage indicators for each hour in each day for average calculation to obtain 24 average values of each of the resource usage indicators, which constitute a vector (that is, a resource usage indicator vector). In this way, seven resource usage indicator vectors may be obtained, each resource usage indicator vector includes 24 elements, with each element value being the statistical average value of the resource usage indicator within one hour. Then, the electronic device may compare seven element values corresponding to the same vector subscript in the seven resource usage indicator vectors to obtain a maximum value corresponding to each vector subscript, and use these 24 maximum values to form a load vector of the service replica in the QPS dimension. According to this process, the load vector of each of the service replicas in each of the service nodes in each load dimension may be calculated, so as to obtain the multi-dimensional load vector of each of the service replicas in each of the service nodes. In this way, it is possible to obtain more representative dynamic load condition of the service replica.

At step C, summation processing is performed on the multi-dimensional load vector of each of the service replicas of each of the service nodes in element-by-element positions in a dimension-by-dimension manner, and the multi-dimensional load vector of each of the service nodes is generated based on a maximum value in a summation processing result in each dimension.

Specifically, the service node includes a plurality of service replicas, and a load sum of the service replicas may represent the resource utilization of the service node. Therefore, the electronic device may perform summation calculation on element values with the same vector subscript in the multi-dimensional load vector of all the service replicas in the service node which are calculated above, and the obtained result constitutes a load vector of the service node in each load dimension, where the number of elements of the load vector is consistent with the number of elements of the multi-dimensional load vector of the service replica. Then, the maximum value in the load vector in each load dimension is counted and used as a load value of the service node in the load dimension. The load values in the plurality of load dimensions constitute the multi-dimensional load vector of the service node.

Continuing with the above example, if a service node includes n service replicas, the electronic device may calculate a sum of n maximum values for each of the same vector subscripts in the load vector in the QPS dimension of the n service replicas to obtain a summation result of 24 maximum values, which constitutes a load vector of the service node in the QPS dimension. Then, the electronic device compares the 24 element values in the load vector and determines a maximum value of the 24 element values as the load value of the service node in the QPS dimension. In this way, the load value of the service node in each load dimension may be calculated to constitute the multi-dimensional load vector of the service node.

In the above process, the load calculation is performed on the service node by first performing summation aggregation and then performing maximum aggregation, which may solve the above problem (3) and improve the accuracy of the target load value.

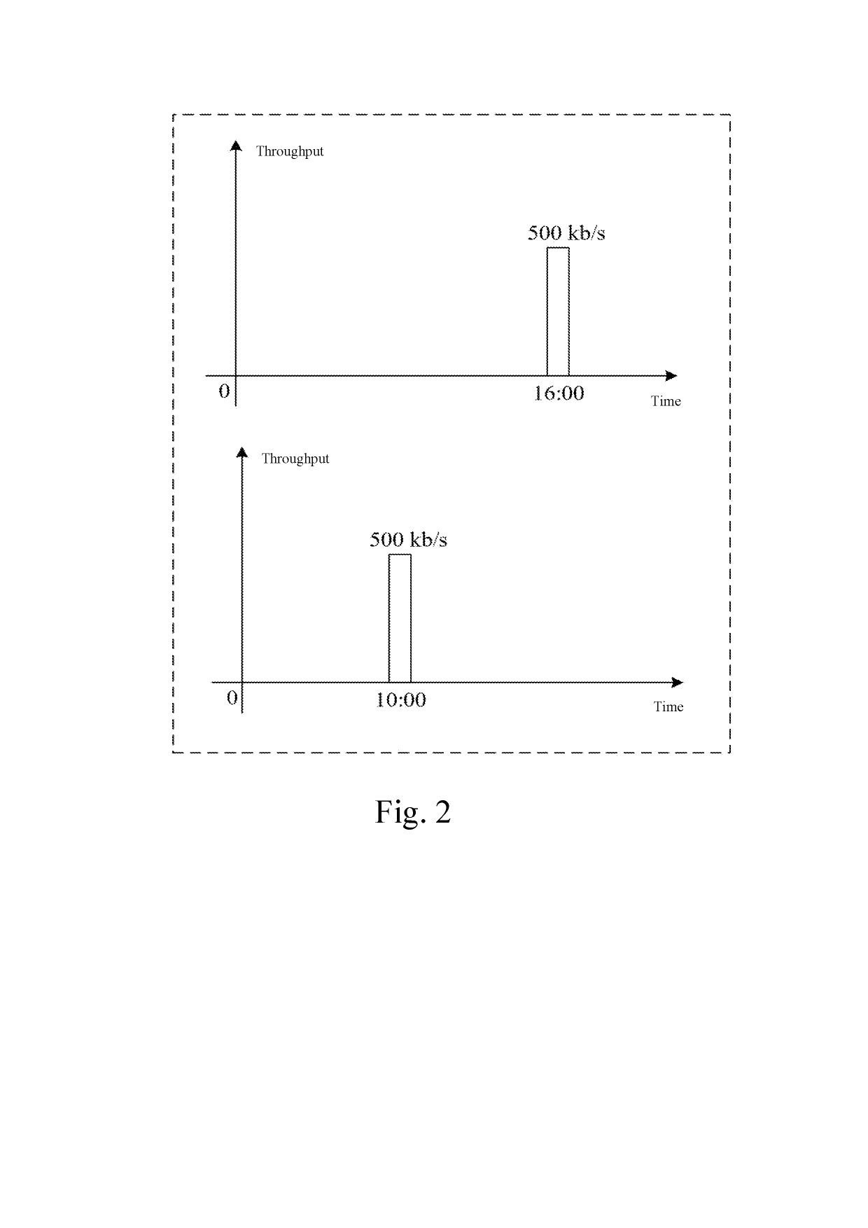

For example, referring to FIG. 2, it is assumed that there are two service replicas on a service node, and the throughput of these two service replicas at two moments of 10:00 and 16:00 is 500 kb/s, while the throughput at other moments is zero. In this scenario, the throughput load peak of the service node is 500 kb/s. Therefore, when calculating the load value of the service node in the throughput dimension, it is more reasonable to first perform the summation aggregation in the vector dimension and then perform the maximum aggregation. If the maximum value is first obtained and then the summation aggregation is performed, the load value of the service node will be calculated as an incorrect 1000 kb/s.

At step S120, the service nodes are classified into multiple load intervals based on the multi-dimensional load vector and a target load vector of each of the service nodes.

The target load vector is a vector composed of load values when a balancing state of resource utilization is reached in each load dimension. The load interval corresponds to a certain load value range. The multiple load intervals at least include a high load interval and a low load interval. The high load interval is a load value interval where an overall load of the service node is too high. The low load interval is a load value interval where the overall load of the service node is too low.

Specifically, the electronic device may classify each of the service nodes into different load intervals according to a gap between the multi-dimensional load vector and the target load vector of each of the service nodes. For example, when the multi-dimensional load vector is much greater than the target load vector, the corresponding service node may be classified into the high load interval; when the multi-dimensional load vector is much less than the target load vector, the corresponding service node may be classified into the low load interval; and when the difference between the multi-dimensional load vector and the target load vector is relatively small, the corresponding service node may be classified into the load interval with relatively balancing load (referred to as the balancing load interval). In this way, the service nodes that need to participate in scheduling of the service replica may be selected.

During specific implementation, comprehensive load judgment in multiple dimensions is complex and has high uncertainty. In the embodiments of the present disclosure, load interval division may be performed for each load dimension. In this way, the target load vector may also be split according to the load dimension to provide reference load values for participating in interval division in each load dimension. Then, the load value of each of the service nodes in each load dimension is compared with a high load threshold and a low load threshold determined based on the reference load value. If the load value is greater than the high load threshold, the service node is classified into the high load interval in the load dimension. If the load value is less than or equal to the low load threshold, the service node is classified into the low load interval in the load dimension. In this way, all the service nodes may be classified into different load intervals to obtain the possible high-load service node and the possible low-load service node in all the load dimensions.

In some embodiments, S120 includes: classifying the service node into the low load interval if a load value in any dimension in the multi-dimensional load vector of the service node is less than or equal to a difference between a load value in the corresponding dimension in the target load vector and a first load tilt; classifying the service node into the high load interval if the load value in any dimension in the multi-dimensional load vector of the service node is greater than a sum of a load value in the corresponding dimension in the target load vector and a second load tilt; and classifying the service node into a balancing load interval if the load value in any dimension in the multi-dimensional load vector of the service node is greater than a sum of a load value in a corresponding dimension in the target load vector and the first load tilt and less than or equal to a sum of a load value in the corresponding dimension in the target load vector and the second load tilt.

The first load tilt and the second load tilt are both preset load tilts, which may be set according to business requirements. For example, if a business requirement is that the CPU utilization is allowed to tilt by 10%, both the first load tilt and the second load tilt in the CPU utilization dimension may be set to 5%. It should be noted that the first load tilt and the second load tilt may also be set to different values.

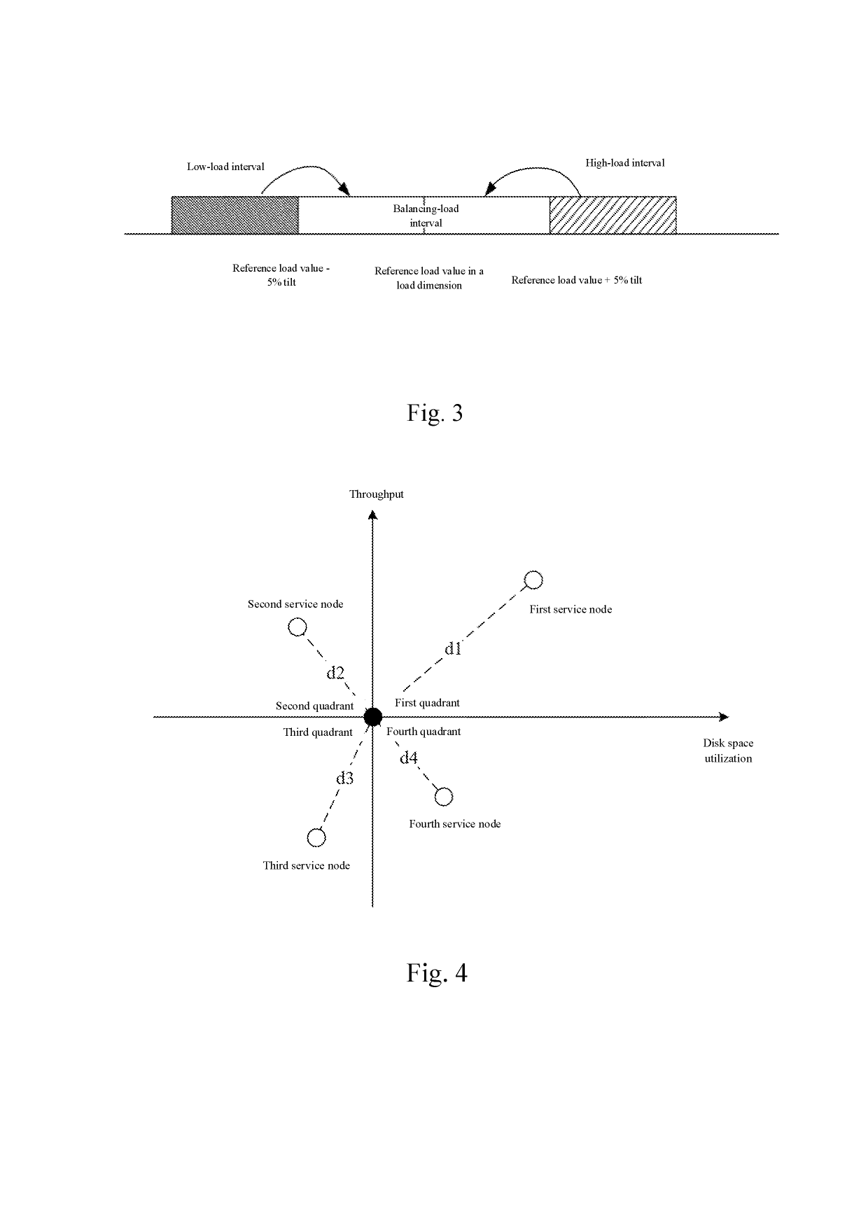

Specifically, for each load dimension, the electronic device may take a difference between the corresponding reference load value in the target load vector and the first load tilt (for example, reference load value - 5% tilt) as a low load threshold, and take a sum of the reference load value and the second load tilt (for example, reference load value + 5% tilt) as a high load threshold. Referring to FIG. 3, the electronic device may first determine the optimal reference load value corresponding to any load dimension, then subtract the first load tilt from the reference load value to determine the low load threshold, and add the second load tilt to the reference load value to determine the high load threshold. In this way, load interval division may be performed in this load dimension to obtain the high load interval in the diagonally hatched example part, the low load interval in the black dot-filled example part, and the balancing load interval in the white-filled example part.

On this basis, the load value of the multi-dimensional load vector of each of the service nodes in the load dimension is compared with the high load threshold and the low load threshold. When the load value is in a range of (reference load value - 5% tilt, reference load value + 5% tilt], the service node may be classified into the balancing load interval, it may be considered that the load distribution of the service node in the load dimension is relatively balanced, and the present disclosure may not perform additional processing on it. When the load value is in a range of (-∞, reference load value - 5% tilt], the service node may be classified into the low load interval, and the service replica needs to be scheduled to the service node for load balancing scheduling. When the load value is in a range of (reference load value + 5% tilt, +∞], the service node may be classified into the high load interval, and the service replica needs to be scheduled from the service node for load balancing scheduling.

Referring to FIG. 4, taking the throughput dimension and the disk space utilization dimension as an example, the reference load values corresponding to the two dimensions may constitute the origin of a two-dimensional spatial coordinate system (an example of a black filled dots), and the two-dimensional spatial coordinate system includes four quadrants. The throughput and the disk space utilization in the first quadrant are both higher than the reference load values in the corresponding dimensions. The throughput in the second quadrant is higher than the reference load value in the corresponding dimension, while the disk space utilization is lower than the reference load value in the corresponding dimension. The throughput and the disk space utilization in the third quadrant are both lower than the reference load values in the corresponding dimensions. The throughput in the fourth quadrant is lower than the reference load value in the corresponding dimension, while the disk space utilization is higher than the reference load value in the corresponding dimension. It may be determined that the first service node in the first quadrant represents a service node with overall high load, and it may be classified into the high load interval corresponding to both the throughput dimension and the disk space utilization dimension. The third service node in the third quadrant represents a service node with overall low load, and it may be classified into the low load interval corresponding to both the throughput dimension and the disk space utilization dimension. The second service node in the second quadrant and the fourth service node in the fourth quadrant may belong to the service node with overall high load or the service node with overall low load, and it is not easy to perform overall load judgment on the two service nodes. Therefore, the second service node may be classified into the high load interval and the fourth service node may be classified into the low load interval in the throughput dimension, while the fourth service node may be classified into the low load interval and the fourth service node may be classified into the high load interval in the disk space utilization dimension. In this way, according to the embodiments of the present disclosure, all the service nodes are classified in each load dimension , which may ensure that the potential low-load service node appears at least once in the low load interval, and ensure that the potential high-load service node appears at least once in the high load interval, thereby solving the above problem (1) and ensuring that no service node that may need to perform load balancing scheduling is missed during the load balancing process.

In some embodiments, the reference load value in any load dimension in the target load vector may be a preset load value.

In other embodiments, the reference load value in any load dimension in the target load vector may also be calculated according to the amount of services carried by the system and the total amount of resources of the system. Exemplarily, the reference load value is determined based on an average value of a total amount of resources of the distributed system in the corresponding load dimension relative to a total amount of tasks in the corresponding load dimension. For example, for the throughput dimension, its reference load value = total throughput of services carried by the system / sum of throughput of all service nodes in the system; and for the disk space utilization, its reference load value = total data volume of services carried by the system / sum of disk space capacity of all service nodes in the system.

At step S130, multiple candidate scheduling strategies and corresponding load balancing gains are determined based on the multiple load intervals.

The candidate scheduling strategy instructs to schedule a specified service replica carried by a specified service node in the high load interval to a specified service node in the low load interval. The load balancing gain is used to characterize a load change of the service node before and after scheduling of the service replica, and may be measured by a difference between load vectors of the service node before and after scheduling.

Specifically, a target of load balancing scheduling is to schedule the service replica from the service node in the high load interval to the service node in the low load interval, so as to reduce a deviation between the multi-dimensional load vector and the target load vector of the two service nodes. Therefore, the electronic device may predict multiple feasible candidate scheduling strategies and corresponding load balancing gain according to the multi-dimensional load vectors and the target load vectors of the service nodes in the high load interval and the low load interval, so as to perform scheduling of the service replica according to the load balancing gain. The feasible candidate scheduling strategy herein refers to that the multi-dimensional load vectors of the two service nodes approach the target load vector after scheduling, so as to reduce a load deviation degree.

During specific implementation, the electronic device may determine the degree to which the load of the service node deviates from the balancing load (which may be referred to as a first comprehensive deviation value) according to the multi-dimensional load vector and the target load vector of the service node in the high load interval. The electronic device may also determine a degree to which the load of the service node deviates from the balancing load (which may be referred to as a second comprehensive deviation value) according to the multi-dimensional load vector and the target load vector of the service node in the low load interval. The comprehensive deviation value herein is a degree of load deviation generated in multiple dimensions, which may be implemented as Euclidean distance, Mahalanobis distance, or the like. The greater the comprehensive deviation value is, it indicates that the resource usage of the service node in multiple dimensions is more unbalanced, and the requirement for balance scheduling is higher. Based on this, the electronic device may schedule a certain service replica of a certain service node in the high load interval to a certain service node in the low load interval as a candidate scheduling strategy, and predict a difference between comprehensive deviation values generated by the two service nodes before and after scheduling as the load balancing gain of the candidate scheduling strategy.

For example, taking the measurement indicator of the comprehensive deviation value being the Euclidean distance as an example, for the first service node, the second service node, the third service node, and the fourth service node shown in FIG. 4, the Euclidean distance d1, the Euclidean distance d2, the Euclidean distance d3, and the Euclidean distance d4 may be calculated respectively according to the above method. The greater the value of the Euclidean distance is, it indicates that the corresponding service node deviates from the target load vector to a greater extent in multiple dimensions, and it is more in need of balance scheduling processing. On this basis, the electronic device may determine the load balancing gain of the corresponding candidate scheduling strategy by a gap between the Euclidean distances of the two service nodes before and after scheduling.

At step S140, from the multiple candidate scheduling strategies, a candidate scheduling strategy with the largest load balancing gain is selected as a target scheduling strategy, and the target scheduling strategy is executed, where the largest load balancing gain represents that distances between the multi-dimensional load vector and the target load vector of the each of the service nodes are reduced after participating in scheduling of the service replicas, and the value of the distance reduction is the largest.

Specifically, according to the foregoing description, the load balancing gain corresponding to each candidate load strategy is to make the two service nodes participating in scheduling approach the target load vector as a whole, that is, the degree of deviation between the two service nodes and the target load vector after scheduling is smaller than the degree of deviation between the two service nodes and the target load vector. This process is manifested in a multi-dimensional space that at least one of the two service nodes is close to a space dot (that is, the origin) where the target load vector is located. In order to solve the above problem (2) and achieve load balancing of the entire system faster, the electronic device may select a candidate scheduling strategy with the largest load balancing gain as the service replica scheduling strategy (that is, the target scheduling strategy) finally executed in the load balancing scheduling process. Then, the target scheduling strategy may be executed.

The scheduling of the service replica is continuously performed according to the above process until both the number of the service nodes in the high load interval and the number of the service nodes in the low load interval are less than the first preset number. The first preset number is another preset number value, which may be a smaller value. For example, for an ideal load balancing effect, the first preset number may be set to zero; considering various factors such as the rationality of the setting of the first load tilt and the second load tilt, the actual operation of the system in the practical operation, and so on, the first preset number may be set to a small positive integer greater than zero to improve the fault tolerance of the load balancing of the system.

Referring to FIG. 3, through the above load balancing processing, the service replica may be scheduled from each of the service nodes in the high load interval to each of the service nodes in the low load interval, so that the load tilt of each of the service nodes in the high load interval and the load tilt of each of the service nodes in the low load interval are gradually reduced until the vast majority of the service nodes in the system are classified into the balancing load interval.

It may be seen that according to the embodiments of the present disclosure, the comprehensive deviation value is calculated by the multi-dimensional load vector for load balancing, service replicas with different resource utilization in the same load dimension will be mixed and arranged in the same service node, so as to fully utilize resources of the service node in each dimension. For example, a certain type of service replicas requires higher CPU utilization and lower disk space utilization, while another type of service replicas requires lower CPU utilization and higher disk space utilization. If the same type of service replicas are deployed on the same service node, resources in the CPU utilization dimension or the disk space utilization dimension in the service node will be occupied in a large amount, while resources in another load dimension will be idle in a large amount, resulting in serious tilt of resources of the service nodes in each dimension and low overall resource utilization. Through the processing according to the embodiments of the present disclosure, the above different types of service replicas may be scheduled to the same service node for mixed deployment, so as to fully utilize resources in each load dimension as much as possible and achieve better resource balance.

In addition, according to the description of the foregoing embodiments, the load balancing strategy according to the embodiments of the present disclosure is to divide the load intervals of the service nodes according to a single dimension and schedule the service replicas according to the multi-dimensional load vectors. Therefore, when expanding the load dimension, it is only necessary to increase the corresponding first load tilt and second load tilt to divide the intervals of each of service nodes. Therefore, the load balancing strategy according to the embodiments of the present disclosure may solve the above problem (4) to quickly expand the load dimensions, and can be conveniently extended to any distributed system.

According to the load balancing method for a distributed system according to the foregoing respective embodiments of the present disclosure, it is possible to determine a multi-dimensional load vector of each of service nodes based on resource usage indicators of each of service replicas carried on the each of the service nodes in the distributed system in the multiple dimensions, where the multi-dimensional load vector represents a resource utilization of the service nodes in multiple dimensions; divide the each of the service nodes into multiple load intervals based on the multi-dimensional load vector and a target load vector of the each of the service nodes; determine multiple candidate scheduling strategies and corresponding load balancing gains based on the multiple load intervals, where the candidate scheduling strategy instructs to schedule a specified service replica carried by a specified service node in the high load interval to a specified service node in the low load interval; and select, from the multiple candidate scheduling strategies, a candidate scheduling strategy with the largest load balancing gain as a target scheduling strategy, and execute the target scheduling strategy, where the largest load balancing gain represents that distances between the multi-dimensional load vector and the target load vector of the each of the service nodes are reduced before and after participating in scheduling of the service replica, and the value of the distance reduction is the largest. It achieves a comprehensive measurement of the resource utilization of each of service nodes in multiple load dimensions. Based on this, load balancing scheduling of service replicas is carried out. As a result, service replicas with interactive characteristics of resource utilization in each load dimension are mixed and arranged in each service node, such that loads of each of service nodes distributed within the surrounding range of the balancing target load vector, thus simultaneously balancing the resource utilization of the distributed system in all load dimensions, and significantly improving the system's resource utilization while reducing system costs.

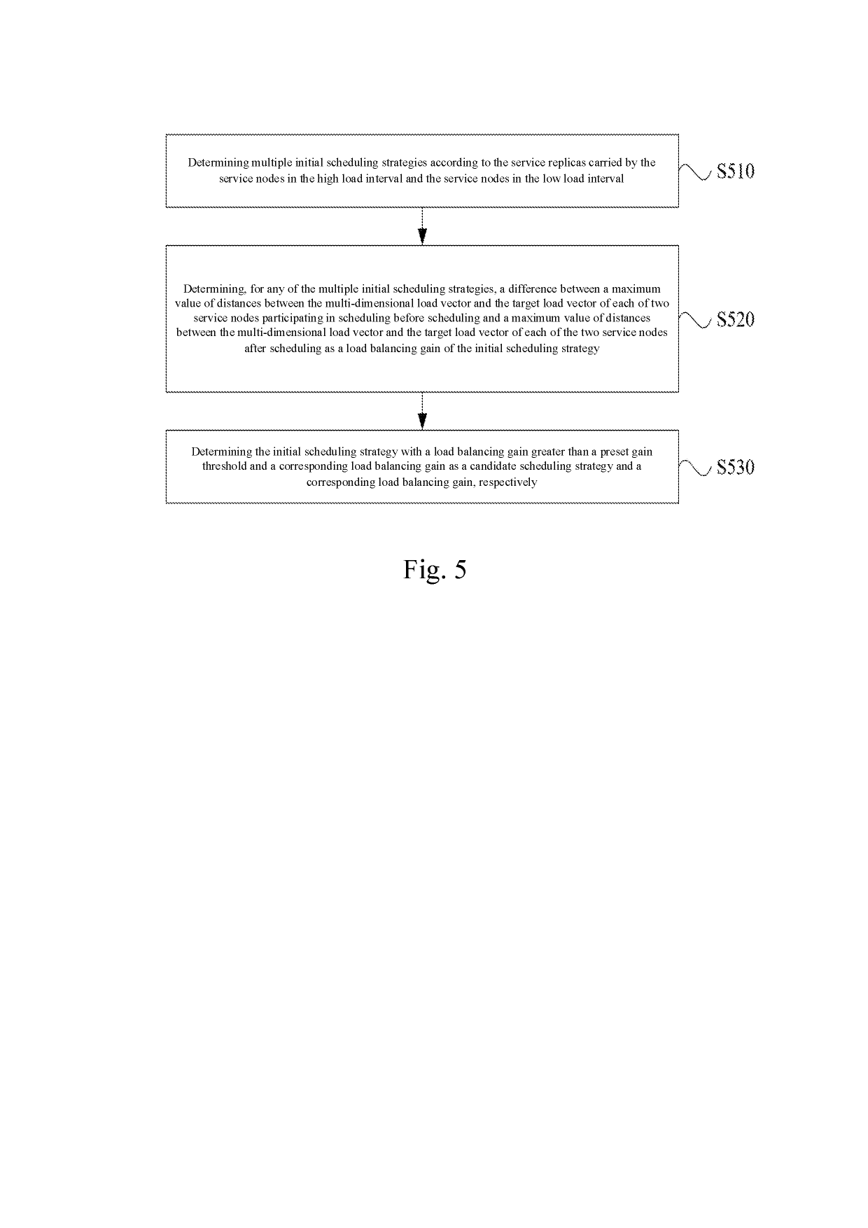

FIG. 5 is a schematic flowchart of S130 in the load balancing method for the distributed system shown in FIG. 1 according to an embodiment of the present disclosure, which elaborates on how to perform the load balancing strategy of scheduling the service replica. Referring to FIG. 5, the "determining multiple candidate scheduling strategies and corresponding load balancing gains based on the multiple load intervals" in S130 specifically includes the following steps S510, S520 and S530.

At step S510, multiple initial scheduling strategies are determined according to service replicas carried by service nodes in a high load interval and service nodes in low load interval.

Specifically, the electronic device may formulate a scheduling strategy of scheduling any service replica from any service node in the high load interval to any service node in the low load interval as the initial scheduling strategy.

In some embodiments, S510 includes: scheduling any service replica carried by a service node in the high load interval to any one of a preset number of randomly selected service nodes in the low load interval to determine multiple initial scheduling strategies.

The preset number is a preset number value, which is less than the total number of all service nodes in the low load interval corresponding to each load dimension.

Specifically, the electronic device may determine any service replica from any service node in the high load interval to participate in scheduling, and at the same time, randomly select any one of the preset number of service nodes from the low load interval in all load dimensions to receive the scheduled service replica, thus constituting an initial scheduling strategy. In this way, it may be avoided that service nodes in a certain high load interval are continuously scheduled to the same service node in the low load interval, thereby preventing the problem that the service replica scheduling task cannot be completed normally when the service nodes in the low load interval fails.

In some embodiments, S510 further includes: sorting the respective service nodes in the high load interval in descending order according to distances between the multi-dimensional load vectors of the service nodes in the high load interval and the target load vectors; and scheduling any service replica carried by a service node in the high load interval to a service node in the low load interval according to the sorting result to determine multiple initial scheduling strategies.

Specifically, in order to enable the system to achieve load balancing faster, the electronic device may first sort the respective service nodes in the high load interval in descending order according to distances between the respective service nodes and the target load vector. Then, the service replicas in a corresponding service node is sequentially scheduled to the service node in the low load interval according to the sorting result, thereby constructing the initial scheduling strategy.

At step S520, for any initial scheduling strategy, a difference between a maximum value of distances between the multi-dimensional load vectors and the target load vectors of the two service nodes participating in scheduling before scheduling and a maximum value of distances between the multi-dimensional load vectors and the target load vectors of the two service nodes after scheduling as the load balancing gain of the any initial scheduling strategy.

Specifically, considering the complexity of the system operation process, in this embodiment, the load tilts of the service nodes in the high load interval and the load tilts of the service nodes in the low load interval may be comprehensively considered for processing. Considering that the system performance depends on the maximum value of the distances between the multi-dimensional load vectors and the target load vectors, the electronic device may take the maximum value of the distances between the multi-dimensional load vectors and the target load vectors of the two service nodes participating in scheduling before scheduling as the load tilt of the two service nodes before scheduling, and take the maximum value of the distances between the multi-dimensional load vectors and the target load vectors of the two service nodes after scheduling as the load tilt of the two service nodes after scheduling. Then, the change in the comprehensive load tilt before and after scheduling is taken as the load balancing gain of the initial scheduling strategy.

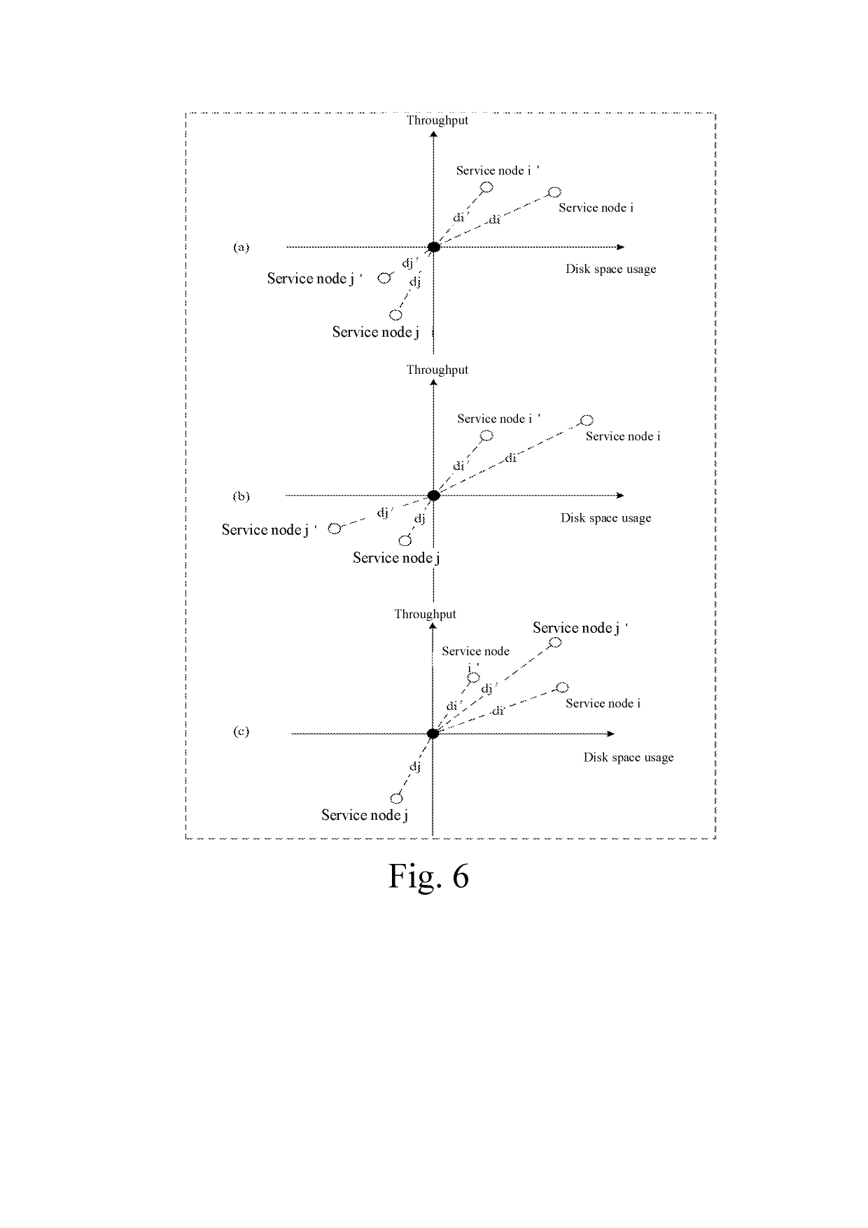

For example, referring to FIG. 6, a certain service node in the high load interval is marked as i, di represents a distance between its multi-dimensional load vector and the target load vector before scheduling, and di′ represents a distance between its multi-dimensional load vector and the target load vector after scheduling. A certain service node in the low load interval is marked as j, dj represents a distance between its multi-dimensional load vector and the target load vector before scheduling, and dj′ represents a distance between its multi-dimensional load vector and the target load vector after scheduling. Then, the maximum value of the distances between the multi-dimensional load vectors and the target load vectors of the two service nodes participating in scheduling before scheduling may be expressed as max(di, dj), and the maximum value of the distances between the multi-dimensional load vectors and the target load vectors of the two service nodes after scheduling may be expressed as max(di′, dj′). On basis of this, the load balancing gain of the initial scheduling strategy is expressed as max(di, dj) - max(di′, dj′).

At step S530, an initial scheduling strategy with a load balancing gain greater than a preset gain threshold and the corresponding load balancing gain are determined as a candidate scheduling strategy and the corresponding load balancing gain.

The preset gain threshold is a preset load balancing gain for judging whether the distance between the multi-dimensional load vectors and the target load vectors of the two service nodes after scheduling the service replica tends to decrease as a whole. For example, the preset gain threshold may be a positive number greater than or equal to zero.

Specifically, according to the foregoing description, the electronic device needs to select the initial scheduling strategy with the reduced comprehensive load tilt of the two service nodes after scheduling, that is, select the initial scheduling strategy with the load balancing gain greater than the preset gain threshold as the candidate scheduling strategy. The load balancing gain of the selected initial scheduling strategy represents the load balancing gain of the candidate scheduling strategy.

For example, a scheduling result of the initial scheduling strategy may be that one service node is slightly away from the space dot corresponding to the target load vector while another service node is closer to the space dot corresponding to the target load vector to a greater extent, so as to ensure that a summary result of the two service nodes is close to the space dot corresponding to the optimal target load vector as a whole. For another example, a scheduling result of the initial scheduling strategy may be that both of the two service nodes are close to the space dot corresponding to the target load vector to different extents. The load balancing gain of such an initial scheduling strategy is greater than the preset gain threshold, which may be used as the candidate scheduling strategy.

If the load balancing gain obtained by a certain initial scheduling strategy is that the distance between the multi-dimensional vectors of the two service nodes and the target load vector after scheduling is greater than the distance between the multi-dimensional vectors of the two service nodes and the target load vector before scheduling, it indicates that the two service nodes will deviate more from the space dot corresponding to the target load vector after scheduling, which will aggravate the load tilt of the two service nodes, and the load balancing gain of such an initial scheduling strategy is less than or equal to the preset gain threshold, and the initial scheduling strategy is discarded.

Taking FIG. 6 as an example, an overall example of determining the candidate scheduling strategy is described below.

Referring to FIG. 6(a), it is assumed that after the initial scheduling strategy is executed, a distance di′ between the multi-dimensional load vector and the target load vector of the service node i in the high load interval after scheduling is less than a distance di between the multi-dimensional load vector and the target load vector of the service node i before scheduling, and a distance dj′ between the multi-dimensional load vector and the target load vector of the service node j in the low load interval after scheduling is less than a distance dj between the multi-dimensional load vector and the target load vector of the service node j before scheduling. The overall load tilt of the two service nodes is reduced, so the load balancing gain of the initial scheduling strategy is greater than the preset gain threshold, the initial scheduling strategy is feasible, and the electronic device may determine the initial scheduling strategy as the candidate scheduling strategy.

Referring to FIG. 6(b), it is assumed that after the initial scheduling strategy is executed, a distance di′ between the multi-dimensional load vector and the target load vector of the service node i in the high load interval after scheduling is less than a distance di between the multi-dimensional load vector and the target load vector of the service node i before scheduling, and a distance dj′ between the multi-dimensional load vector and the target load vector of the service node j in the low load interval after scheduling is greater than a distance dj between the multi-dimensional load vector and the target load vector of the service node j before scheduling, but the largest dj′ after scheduling is still less than the largest di before scheduling. Therefore, the overall load tilt of the two service nodes is still reduced, so the load balancing gain of the initial scheduling strategy is greater than the preset gain threshold, the initial scheduling strategy is feasible, and the electronic device may determine the initial scheduling strategy as the candidate scheduling strategy.

Referring to FIG. 6(c), it is assumed that after the initial scheduling strategy is executed, a distance di′ between the multi-dimensional load vector and the target load vector of the service node i in the high load interval after scheduling is less than a distance di between the multi-dimensional load vector and the target load vector of the service node i before scheduling, a distance dj′ between the multi-dimensional load vector and the target load vector of the service node j in the low load interval after scheduling is greater than a distance dj between the multi-dimensional load vector and the target load vector of the service node j before scheduling, and the largest dj′ after scheduling is also greater than the largest di before scheduling. That is, the largest load tilt of the two service nodes after scheduling is greater than the largest load tilt of the two service nodes before scheduling, which indicates that the overall load tilt of the two service nodes is increased rather than decreased, which aggravates the load imbalance of the system. Therefore, the load balancing gain of the initial scheduling strategy is less than the preset gain threshold, the initial scheduling strategy is not feasible, and the electronic device may discard the initial scheduling strategy.

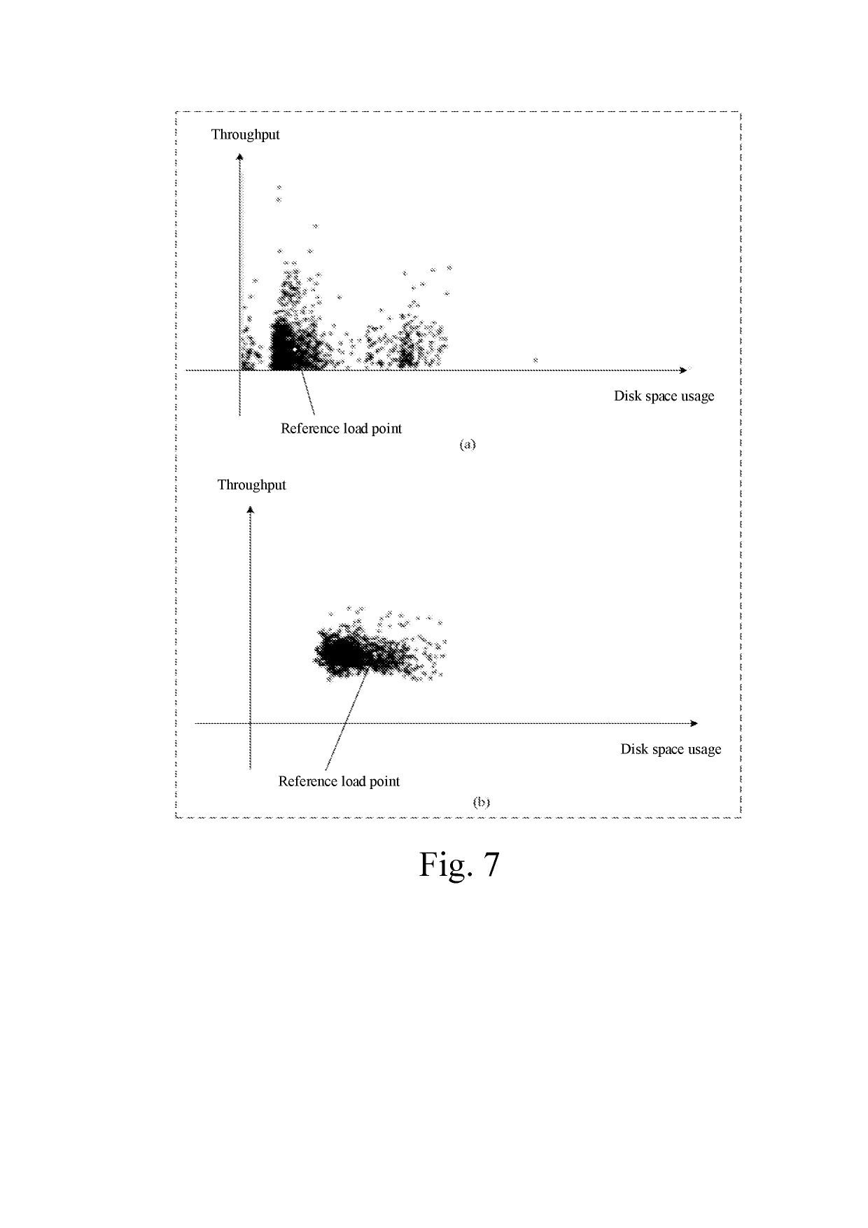

Referring to FIG. 7, the execution effect of the load balancing method in the embodiments of the present disclosure is described. As shown in FIG. 7(a), before the load balancing method according to the embodiments of the present disclosure is executed, the load tilts among respective service nodes is large, and the multi-dimensional load vector of respective service nodes is greatly deviated from the space dot corresponding to the target load vector to different degrees. In addition, there is an obvious tilt in the resource utilization in different dimensions among the service nodes. The disk space utilization of some service nodes is high while the throughput is low, and the throughput of another part of service nodes is high while the disk space utilization is low. As shown in FIG. 7(b), after the load balancing method according to the embodiments of the present disclosure is executed, the loads of all the service nodes are distributed in a rectangular range centered on the space dot corresponding to the optimal target load vector. Moreover, the length and width of the rectangle correspond to the first load tilt and the second load tilt corresponding to the two load dimensions, respectively.

The following are embodiments of the load balancing apparatus for a distributed system according to the embodiments of the present invention. The apparatus belongs to the same inventive concept as the load balancing method for a distributed system according to the foregoing embodiments. For the details not described in detail in the embodiments of the load balancing apparatus for a distributed system, reference may be made to the embodiments of the load balancing method for the distributed system described above.

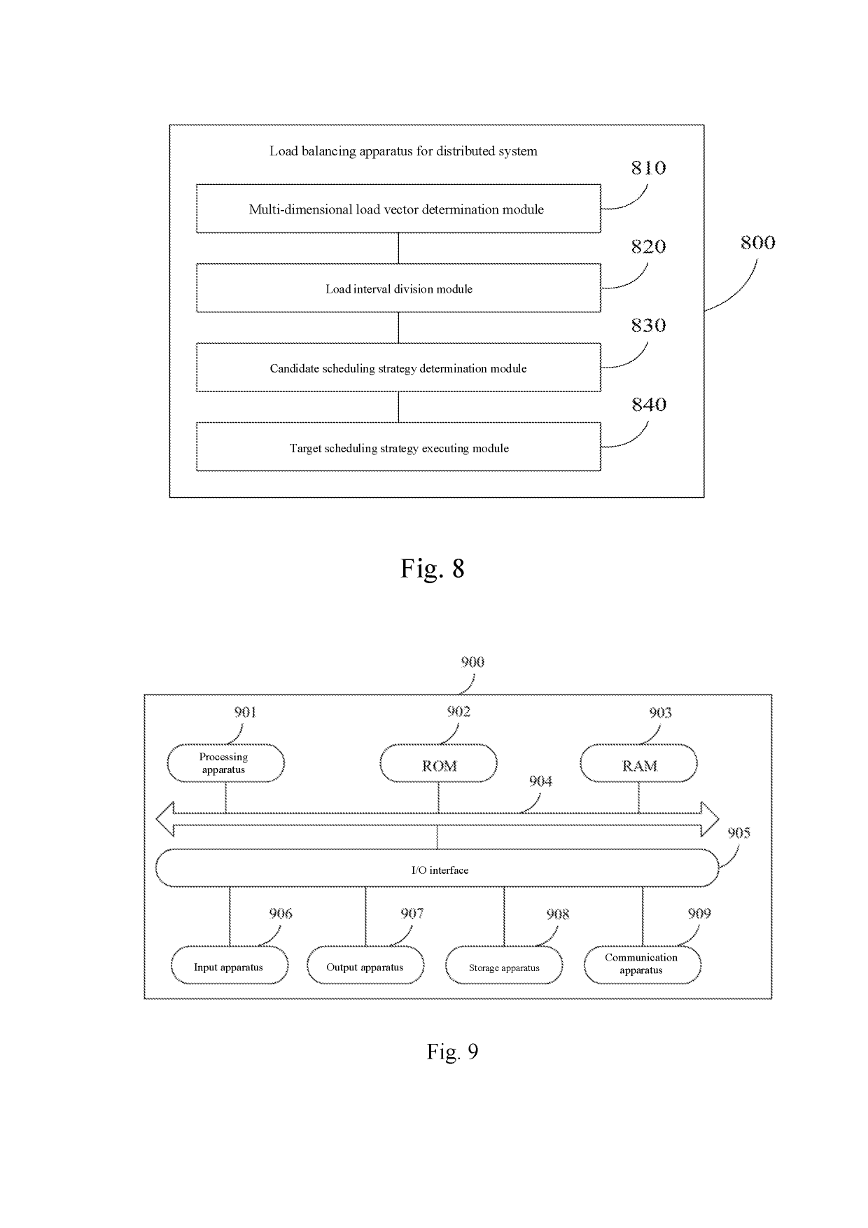

FIG. 8 shows a schematic structural diagram of a load balancing apparatus for a distributed system according to an embodiment of the present disclosure. As shown in FIG. 8, the load balancing apparatus 800 for a distributed system may include:

a multi-dimensional load vector determination module 810, configured to determine a multi-dimensional load vector of each of service nodes based on resource usage indicators of each of service replicas carried on the service nodes in the distributed system in the multiple dimensions, where the multi-dimensional load vector represents a resource utilization of each of the service nodes in multiple dimensions;

a load interval division module 820, configured to divide each of the service nodes into multiple load intervals based on the multi-dimensional load vector and a target load vector of each of the service nodes, where the multiple load intervals at least include a high load interval and a low load interval;

a candidate scheduling strategy determination module 830, configured to determine multiple candidate scheduling strategies and corresponding load balancing gains based on the multiple load intervals, where the candidate scheduling strategy instructs to schedule a specified service replica carried by a specified service node in the high load interval to a specified service node in the low load interval; and

a target scheduling strategy executing module 840, configured to select, from the multiple candidate scheduling strategies, a candidate scheduling strategy with the largest load balancing gain as a target scheduling strategy, and execute the target scheduling strategy, where the largest load balancing gain represents that distances between the multi-dimensional load vector and the target load vector of each of the service nodes are reduced after participating in scheduling of the service replica, and a reduction value of the distances is the largest.

In some embodiments, the load interval division module 820 is specifically configured to:

classify the service node into the low load interval if the load value in any dimension in the multi-dimensional load vector of the service node is less than or equal to a difference between the load value in the corresponding dimension in the target load vector and the first load tilt;

classify the service node into the high load interval if the load value in any dimension in the multi-dimensional load vector of the service node is greater than a sum of the load value in the corresponding dimension in the target load vector and the second load tilt; and

classify the service node into the balancing load interval if the load value in any dimension in the multi-dimensional load vector of the service node is greater than a sum of the load value in the corresponding dimension in the target load vector and the first load tilt and less than or equal to a sum of the load value in the corresponding dimension in the target load vector and the second load tilt.

In some embodiments, the candidate scheduling strategy determination module 830 includes:

an initial scheduling strategy determining sub-module, configured to determine multiple initial scheduling strategies according to the service replicas carried by the service nodes in the high load interval and the service nodes in the low load interval;

a load balancing gain determining sub-module, configured to determine, for any initial scheduling strategy, a difference between a maximum value of distances between the multi-dimensional load vector and the target load vector of the two service nodes participating in scheduling before scheduling and a maximum value of distances between the multi-dimensional load vectors and the target load vectors of the two service nodes after scheduling as a load balancing gain of the initial scheduling strategy; and

a candidate scheduling strategy determining sub-module, configured to determine an initial scheduling strategy with a load balancing gain greater than a preset gain threshold and the corresponding load balancing gain as a candidate scheduling strategy and the corresponding load balancing gain.

In some embodiments, the initial scheduling strategy determining sub-module is specifically configured to:

schedule any service replica carried by a service node in the high load interval to any one of a preset number of randomly selected service nodes in the low load interval to determine multiple initial scheduling strategies.

In some embodiments, the multi-dimensional load vector determination module 810 is specifically configured to:

acquire an average value of a multi-dimensional resource usage indicator generated by each of service replicas carried by each of service nodes in each of multiple statistical unit time in the multiple statistical unit time;

generate a multi-dimensional load vector of each of the service replicas based on a maximum value of the average values of the resource usage indicator generated in each of the statistical unit times; and

perform summation processing on the multi-dimensional load vector of each of the service replicas of each of the service nodes in element-by-element positions in a dimension-by-dimension manner, and generate the multi-dimensional load vector of each of the service nodes based on a maximum value in a summation processing result in each dimension.

In some embodiments, the multi-dimensional load vector includes load values in multiple dimensions that measure processing performance of the distributed system. The multiple dimensions at least include at least two of a throughput dimension, a disk space utilization dimension, a disk input/output dimension, a disk access frequency dimension, a CPU utilization dimension, a memory utilization dimension, a network bandwidth utilization dimension, and an average response time dimension.

In some embodiments, the initial scheduling strategy determining sub-module is specifically configured to:

sort the respective service nodes in the high load interval in descending order according to distances between the multi-dimensional load vector of each of the service nodes in the high load interval and the target load vector; and

schedule any service replica carried by a service node in the high load interval to a service node in the low load interval according to a sorting result to determine multiple initial scheduling strategies.

The load balancing apparatus for a distributed system provided in the embodiments of the present invention may execute the load balancing method for a distributed system provided in any embodiment of the present invention, and has corresponding functional modules and beneficial effects for executing the method.

It should be noted that in the above embodiments of the load balancing apparatus for a distributed system, the respective modules and sub-modules included in the load balancing apparatus are only divided according to functional logic, but are not limited to the above division, as long as the corresponding functions may be realized. In addition, the specific names of the respective functional modules/sub-modules are only used to facilitate distinction from each other, and are not intended to limit the protection scope of the present disclosure.

The embodiments of the present disclosure further provide an electronic device. The electronic device may include a processor and a memory. The memory may be configured to store an executable instruction. The processor may be configured to read the executable instruction from the memory and execute the executable instruction to implement the load balancing method for the distributed system in the above embodiments.

FIG. 9 shows a schematic structural diagram of an electronic device according to an embodiment of the present disclosure.

As illustrated in FIG. 9, the electronic device 900 may include a processing apparatus 901 (e.g., a central processing unit, a graphics processing unit, etc.), which may perform various suitable actions and processing according to a program stored in a read-only memory (ROM) 902 or a program loaded from a storage apparatus 908 into a random-access memory (RAM) 903. The RAM 903 further stores various programs and data required for operations of the electronic device 900. The processing apparatus 901, the ROM 902, and the RAM 903 are interconnected by means of a bus 904. An input/output (I/O) interface 905 is also connected to the bus 904.

Usually, the following apparatus may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the electronic device 900 to be in wireless or wired communication with other devices to exchange data.

It should be noted that the electronic device 900 shown in FIG. 9 is merely an example, and it should not impose any limitations on the functions and scope of use of the embodiments of the present disclosure. While FIG. 9 illustrates the electronic device 900 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the load balancing method of the distributed system of any embodiment of the present disclosure are executed.

Embodiments of the present disclosure also provide a computer-readable storage medium. The storage medium stores a computer program, and when the computer program is executed by a processor, the processor is enabled to implement the load balancing method of the distributed system in any embodiment of the present disclosure.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is enabled to execute the load balancing method of the distributed system described in any embodiment of the present disclosure.

In embodiments of the present disclosure, the computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user’s computer, partly on the user’s computer, as a stand-alone software package, partly on the user’s computer and partly on a remote computer, or entirely on the remote computer or server. In the scenario related to the remote computer, the remote computer may be connected to the user’s computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of devices, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the computer may be a tangible medium that may include or store a program for use by or in combination with an instruction execution system, apparatus or device. The computer-readable medium may be a computer-readable signal medium or a computer-readable storage medium. The computer-readable medium includes, but is not limited to, an electrical, magnetic, optical, electromagnetic, infrared, or semi-conductive system, apparatus or device, or any suitable combination of the foregoing. More specific examples of computer-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A load balancing method for a distributed system, comprising:
determining a multi-dimensional load vector of each of service nodes based on resource usage indicators of each of service replicas carried on each of the service nodes in the distributed system in multiple dimensions, wherein the multi-dimensional load vector represents a resource utilization of each of the service nodes in the multiple dimensions;
classifying the service nodes into multiple load intervals based on the multi-dimensional load vector and a target load vector of each of the service nodes, wherein the multiple load intervals at least comprise a high load interval and a low load interval;
determining multiple candidate scheduling strategies and corresponding load balancing gains based on the multiple load intervals, wherein each of the multiple candidate scheduling strategies instructs to schedule a specified service replica carried by a specified service node in the high load interval to a specified service node in the low load interval; and
selecting, from the multiple candidate scheduling strategies, a candidate scheduling strategy with a largest load balancing gain as a target scheduling strategy, and executing the target scheduling strategy, wherein the largest load balancing gain represents that a distance between the multi-dimensional load vector and the target load vector of each of the service nodes are reduced after participating in scheduling of the service replicas, with a largest reduction value of the distance.

2. The load balancing method according to claim 1, wherein the classifying the service nodes into multiple load intervals based on the multi-dimensional load vector and a target load vector of each of the service nodes, comprises:
classifying one of the service nodes into the low load interval when a load value in any dimension in the multi-dimensional load vector of the one of the service nodes is less than or equal to a difference between a load value in a corresponding dimension in the target load vector and a first load tilt;
classifying one of the service nodes into the high load interval when the load value in any dimension in the multi-dimensional load vector of the one of the service nodes is greater than a sum of a load value in a corresponding dimension in the target load vector and a second load tilt; and
classifying one of the service nodes into a balancing load interval when the load value in any dimension in the multi-dimensional load vector of the one of the service nodes is greater than a sum of a load value in a corresponding dimension in the target load vector and the first load tilt and less than or equal to a sum of the load value in the corresponding dimension in the target load vector and the second load tilt.

3. The load balancing method according to claim 1, wherein the determining multiple candidate scheduling strategies and corresponding load balancing gains based on the multiple load intervals, comprises:
determining multiple initial scheduling strategies according to the service replicas carried by the service nodes in the high load interval and the service nodes in the low load interval;
determining, for any of the multiple initial scheduling strategies, a difference between a maximum value of distances between the multi-dimensional load vector and the target load vector of each of two service nodes participating in scheduling before scheduling and a maximum value of distances between the multi-dimensional load vector and the target load vector of each of the two service nodes after scheduling as a load balancing gain of the initial scheduling strategy; and
determining one of the multiple initial scheduling strategies with a load balancing gain greater than a preset gain threshold and a load balancing gain corresponding to the one of the multiple initial scheduling strategies as one of the multiple candidate scheduling strategies and a load balancing gain corresponding to the one of the multiple candidate scheduling strategies, respectively.

4. The load balancing method according to claim 3, wherein the determining multiple initial scheduling strategies according to the service replicas carried by the service nodes in the high load interval and the service nodes in the low load interval, comprises:
scheduling any one of the service replicas carried by the service nodes in the high load interval to any one of a preset number of service nodes randomly selected from the service nodes in the low load interval to determine the multiple initial scheduling strategies.

5. The load balancing method according to claim 1, wherein the determining a multi-dimensional load vector of each of the service nodes based on the resource usage indicators of each of the service replicas carried on each of the service nodes in the distributed system in the multiple dimensions, comprises:
in multiple statistical unit time, acquiring average values of the resource usage indicators generated by each of service replicas carried by each of service nodes in each of the multiple statistical unit time in the multiple dimensions;
generating a multi-dimensional load vector of each of the service replicas based on a maximum value of the average values of the resource usage indicators generated in the multiple statistical unit time; and
performing summation processing on the multi-dimensional load vector of each of the service replicas of each of the service nodes in element-by-element positions in a dimension-by-dimension manner, and generating the multi-dimensional load vector of each of the service nodes based on a maximum value in a summation processing result in each dimension.

6. The load balancing method according to claim 1, wherein the multi-dimensional load vector comprises load values in multiple dimensions that measure processing performance of the distributed system, and the multiple dimensions at least comprise at least two of a throughput dimension, a disk space utilization dimension, a disk input/output dimension, a disk access frequency dimension, a CPU utilization dimension, a memory utilization dimension, a network bandwidth utilization dimension, and an average response time dimension.

7. The load balancing method according to claim 3, wherein the determining multiple initial scheduling strategies according to the service replicas carried by the service nodes in the high load interval and the service nodes in the low load interval, comprises:
sorting the service nodes in the high load interval in descending order according to a distance between the multi-dimensional load vector of each of the service nodes in the high load interval and the target load vector; and
scheduling any of the service replicas carried by the service nodes in the high load interval to one of the service nodes in the low load interval according to a sorting result to determine the multiple initial scheduling strategies.

8. An electronic device, comprising:
at least one processor; and
a memory, configured to store executable instructions;
wherein the at least one processor are configured to read the executable instructions from the memory and execute the executable instructions to implement a load balancing method for a distributed system,
wherein the load balancing method comprises:
determining a multi-dimensional load vector of each of service nodes based on resource usage indicators of each of service replicas carried on each of the service nodes in the distributed system in multiple dimensions, wherein the multi-dimensional load vector represents a resource utilization of each of the service nodes in multiple dimensions;
classifying the service nodes into multiple load intervals based on the multi-dimensional load vector and a target load vector of each of the service nodes, wherein the multiple load intervals at least comprise a high load interval and a low load interval;
determining multiple candidate scheduling strategies and corresponding load balancing gains based on the multiple load intervals, wherein each of the multiple candidate scheduling strategies instructs to schedule a specified service replica carried by a specified service node in the high load interval to a specified service node in the low load interval; and
selecting, from the multiple candidate scheduling strategies, a candidate scheduling strategy with a largest load balancing gain as a target scheduling strategy, and executing the target scheduling strategy, wherein the largest load balancing gain represents that a distance between the multi-dimensional load vector and the target load vector of each of the service nodes are reduced after participating in scheduling of the service replicas, with a largest reduction value of the distance.

9. The electronic device according to claim 8, wherein the classifying the service nodes into multiple load intervals based on the multi-dimensional load vector and a target load vector of each of the service nodes, comprises:
classifying one of the service nodes into the low load interval when a load value in any dimension in the multi-dimensional load vector of the one of the service nodes is less than or equal to a difference between a load value in a corresponding dimension in the target load vector and a first load tilt;
classifying one of the service nodes into the high load interval when the load value in any dimension in the multi-dimensional load vector of the one of the service nodes is greater than a sum of a load value in a corresponding dimension in the target load vector and a second load tilt; and
classifying one of the service nodes into a balancing load interval when the load value in any dimension in the multi-dimensional load vector of the one of the service nodes is greater than a sum of a load value in a corresponding dimension in the target load vector and the first load tilt and less than or equal to a sum of the load value in the corresponding dimension in the target load vector and the second load tilt.

10. The electronic device according to claim 8, wherein the determining multiple candidate scheduling strategies and corresponding load balancing gains based on the multiple load intervals, comprises:
determining multiple initial scheduling strategies according to the service replicas carried by the service nodes in the high load interval and the service nodes in the low load interval;
determining, for any of the multiple initial scheduling strategies, a difference between a maximum value of distances between the multi-dimensional load vector and the target load vector of each of two service nodes participating in scheduling before scheduling and a maximum value of distances between the multi-dimensional load vector and the target load vector of each of the two service nodes after scheduling as a load balancing gain of the initial scheduling strategy; and
determining one of the multiple initial scheduling strategies with a load balancing gain greater than a preset gain threshold and a load balancing gain corresponding to the one of the multiple initial scheduling strategies as one of the multiple candidate scheduling strategies and a load balancing gain corresponding to the one of the multiple candidate scheduling strategies, respectively.

11. The electronic device according to claim 10, wherein the determining multiple initial scheduling strategies according to the service replicas carried by the service nodes in the high load interval and the service nodes in the low load interval, comprises:
scheduling any one of the service replicas carried by the service nodes in the high load interval to any one of a preset number of service nodes randomly selected from the service nodes in the low load interval to determine the multiple initial scheduling strategies.

12. The electronic device according to claim 8, wherein the determining a multi-dimensional load vector of each of the service nodes based on the resource usage indicators of each of the service replicas carried on each of the service nodes in the distributed system in the multiple dimensions, comprises:
in multiple statistical unit time, acquiring average values of the resource usage indicators generated by each of service replicas carried by each of service nodes in each of the multiple statistical unit time in the multiple dimensions;
generating a multi-dimensional load vector of each of the service replicas based on a maximum value of the average values of the resource usage indicators generated in the multiple statistical unit time; and
performing summation processing on the multi-dimensional load vector of each of the service replicas of each of the service nodes in element-by-element positions in a dimension-by-dimension manner, and generating the multi-dimensional load vector of each of the service nodes based on a maximum value in a summation processing result in each dimension.

13. The electronic device according to claim 8, wherein the multi-dimensional load vector comprises load values in multiple dimensions that measure processing performance of the distributed system, and the multiple dimensions at least comprise at least two of a throughput dimension, a disk space utilization dimension, a disk input/output dimension, a disk access frequency dimension, a CPU utilization dimension, a memory utilization dimension, a network bandwidth utilization dimension, and an average response time dimension.

14. The electronic device according to claim 10, wherein the determining multiple initial scheduling strategies according to the service replicas carried by the service nodes in the high load interval and the service nodes in the low load interval, comprises:
sorting the service nodes in the high load interval in descending order according to a distance between the multi-dimensional load vector of each of the service nodes in the high load interval and the target load vector; and
scheduling any of the service replicas carried by the service nodes in the high load interval to one of the service nodes in the low load interval according to a sorting result to determine the multiple initial scheduling strategies.

15. A non-transitory computer-readable storage medium, wherein the storage medium stores a computer program, and when the computer program is executed by a processor, the processor is caused to implement a load balancing method for a distributed system,
wherein the load balancing method comprises:
determining a multi-dimensional load vector of each of service nodes based on resource usage indicators of each of service replicas carried on each of the service nodes in the distributed system in multiple dimensions, wherein the multi-dimensional load vector represents a resource utilization of each of the service nodes in multiple dimensions;
classifying the service nodes into multiple load intervals based on the multi-dimensional load vector and a target load vector of each of the service nodes, wherein the multiple load intervals at least comprise a high load interval and a low load interval;
determining multiple candidate scheduling strategies and corresponding load balancing gains based on the multiple load intervals, wherein each of the multiple candidate scheduling strategies instructs to schedule a specified service replica carried by a specified service node in the high load interval to a specified service node in the low load interval; and
selecting, from the multiple candidate scheduling strategies, a candidate scheduling strategy with a largest load balancing gain as a target scheduling strategy, and executing the target scheduling strategy, wherein the largest load balancing gain represents that a distance between the multi-dimensional load vector and the target load vector of each of the service nodes are reduced after participating in scheduling of the service replicas, with a largest reduction value of the distance.

16. The non-transitory computer-readable storage medium according to claim 15, wherein the classifying the service nodes into multiple load intervals based on the multi-dimensional load vector and a target load vector of each of the service nodes, comprises:
classifying one of the service nodes into the low load interval when a load value in any dimension in the multi-dimensional load vector of the one of the service nodes is less than or equal to a difference between a load value in a corresponding dimension in the target load vector and a first load tilt;
classifying one of the service nodes into the high load interval when the load value in any dimension in the multi-dimensional load vector of the one of the service nodes is greater than a sum of a load value in a corresponding dimension in the target load vector and a second load tilt; and
classifying one of the service nodes into a balancing load interval when the load value in any dimension in the multi-dimensional load vector of the one of the service nodes is greater than a sum of a load value in a corresponding dimension in the target load vector and the first load tilt and less than or equal to a sum of the load value in the corresponding dimension in the target load vector and the second load tilt.

17. The non-transitory computer-readable storage medium according to claim 15, wherein the determining multiple candidate scheduling strategies and corresponding load balancing gains based on the multiple load intervals, comprises:
determining multiple initial scheduling strategies according to the service replicas carried by the service nodes in the high load interval and the service nodes in the low load interval;
determining, for any of the multiple initial scheduling strategies, a difference between a maximum value of distances between the multi-dimensional load vector and the target load vector of each of two service nodes participating in scheduling before scheduling and a maximum value of distances between the multi-dimensional load vector and the target load vector of each of the two service nodes after scheduling as a load balancing gain of the initial scheduling strategy; and
determining one of the multiple initial scheduling strategies with a load balancing gain greater than a preset gain threshold and a load balancing gain corresponding to the one of the multiple initial scheduling strategies as one of the multiple candidate scheduling strategies and a load balancing gain corresponding to the one of the multiple candidate scheduling strategies, respectively.

18. The non-transitory computer-readable storage medium according to claim 17, wherein the determining multiple initial scheduling strategies according to the service replicas carried by the service nodes in the high load interval and the service nodes in the low load interval, comprises:
scheduling any one of the service replicas carried by the service nodes in the high load interval to any one of a preset number of service nodes randomly selected from the service nodes in the low load interval to determine the multiple initial scheduling strategies.

19. The load balancing method according to claim 15, wherein the determining a multi-dimensional load vector of each of the service nodes based on the resource usage indicators of each of the service replicas carried on each of the service nodes in the distributed system in the multiple dimensions, comprises:
in multiple statistical unit time, acquiring average values of the resource usage indicators generated by each of service replicas carried by each of service nodes in each of the multiple statistical unit time in the multiple dimensions;
generating a multi-dimensional load vector of each of the service replicas based on a maximum value of the average values of the resource usage indicators generated in the multiple statistical unit time; and
performing summation processing on the multi-dimensional load vector of each of the service replicas of each of the service nodes in element-by-element positions in a dimension-by-dimension manner, and generating the multi-dimensional load vector of each of the service nodes based on a maximum value in a summation processing result in each dimension.

20. The non-transitory computer-readable storage medium according to claim 15, wherein the multi-dimensional load vector comprises load values in multiple dimensions that measure processing performance of the distributed system, and the multiple dimensions at least comprise at least two of a throughput dimension, a disk space utilization dimension, a disk input/output dimension, a disk access frequency dimension, a CPU utilization dimension, a memory utilization dimension, a network bandwidth utilization dimension, and an average response time dimension.
